(19) United States
(12) Patent Application Publication
(10) Pub. No.: US 2015/0015609 A1
(43) Pub. Date: Jan. 15, 2015

(54) METHOD OF AUGMENTED REALITY COMMUNICATION AND INFORMATION

(71) Applicant: ALCATEL LUCENT, Paris (FR)

(72) Inventors: Stephanie Plasse, Nozay (FR); Jose Afonso, Paris (FR); Stephane Lefebvre-Mazurel, L'etang La Ville (FR); Olivier Poupel, Rennes (FR); Stephane Dufosse, Nozay (FR)

(73) Assignee: Alcatel-Lucent, Boulogne Billancourt (FR)

(21) Appl. No.: 14/382,959

(22) PCT Filed: Feb. 26, 2013
(86) PCT No.: PCT/FR2013/050381

§ 371 Date: Sep. 4, 2014

(30) Foreign Application Priority Data
Mar. 7, 2012 (FR) 1252051

(51) Int. Cl. G06T 19/00; G06F 17/30; G06K 9/32

(52) U.S. Cl. CPC G06T 19/006; G06K 9/3241; G06F 17/30268
USPC 345/633

(57) ABSTRACT

A communication method comprising the following operations:
taking a shot, by a mobile terminal (2), in the environment of the terminal (2);
analyzing the shot to detect the presence therein of an object;
when an object has been identified by its image, identifying at least one place associated with said object;
taking into account the location of the terminal;
selecting a place associated with the object based on said location;
displaying on the terminal at least one place and piece of information associated with the object.

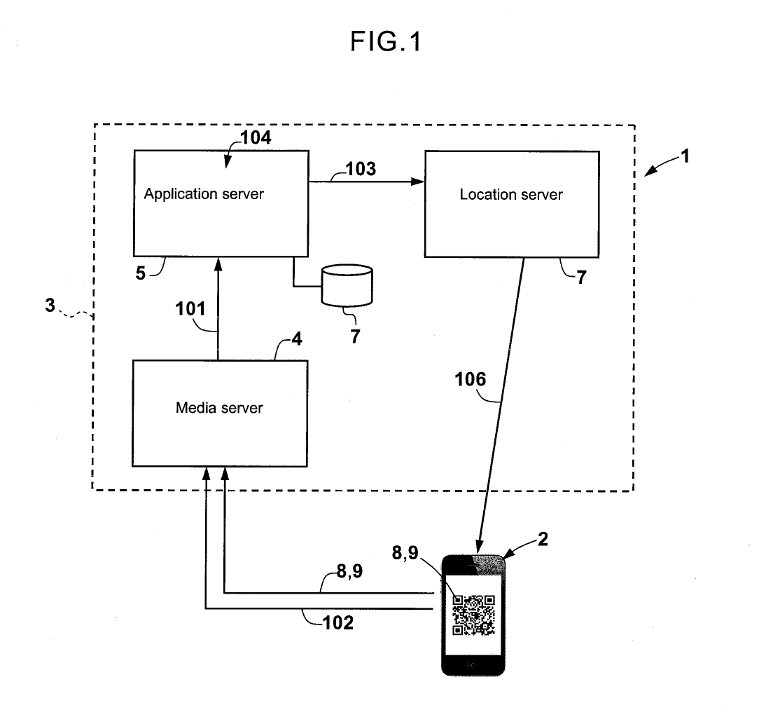

The invention relates to the field of telecommunications.

Third-generation (3G) communication technology has made it possible to integrate a certain number of multimedia services into mobile networks. Furthermore, thanks to the increase in the power of mobile terminals, advanced software applications can be implemented therein, such as satellite navigation combined with interactive informational or advertising services.

For example, one may refer to the American patent U.S. Pat. No. 7,576,644, which describes a method whereby information related to a given physical place is provided to a GPS-located mobile terminal.

The development of mobile terminals equipped with digital cameras, GPS chips, accelerometers, and electronic compasses opens up augmented reality to new applications. Several augmented reality browsers have appeared on the market, including Argon, Wikitude, Layar, as well as various applications (UrbanSpoon, Bionic Eye, Tonchidot).

The application Argon was developed by the Georgia Institute of Technology, with the support of the applicant. As an implementation of the Kharma project, Argon combines the KML and HTML5 standards and has many advantages, particularly in terms of virtual object interactivity and customization. An overview of Argon is given at the address http://argonbrowser.org.

The application Wikitude developed by the company Mobilizy (http://www.wikitude.org) results from integrating Wikipedia, the Android mobile operating system by Google and the smartphone G1 made by HTC. Wikitude makes it possible to add information from Wikipedia atop the image being filmed by the geo-tagged mobile terminal.

The application Layar enables users of the Android application to add information and points of interest, but does not allow the creation of POIs directly within the source code. The operating principles of Layar are as follows: the user selects a subject from a list, then requests information about that subject from a server (GET request), sending the location information to the server. In response, the server gathers the POIs for the chosen subject in the location's vicinity and sends them to the terminal (in the form of a JSON-format document), with the POIs being overlaid on top, and the virtual objects being correctly oriented on the actual objects particularly by detecting the terminal's orientation (for example, a mobile terminal's compass).

The invention particularly intends to offer a communication and information method and system that take into account the centers of interest of a user of a geolocated mobile terminal.

To that end, the invention first proposes a communication method comprising the following operations:

taking a shot, by a mobile terminal, in the environment of the terminal;

analyzing the shot to detect the presence therein of an object;

when an object has been identified by its image, identifying at least one place associated with said object;

taking into account the location of the terminal;

selecting a place associated with the object based on said location;

displaying on the terminal at least one place and piece of information associated with the object.

Here, “mobile terminal” particularly refers to a mobile telephone, a smartphone, a PDA (personal digital assistant), an electronic tablet, or an electronic terminal associated with a vehicle.

The expression “taking a shot” refers to the capturing of an image, that capture potentially being a photo. Advantageously, taking a photo is not necessary, and it is sufficient to position a camera connected to the mobile terminal to take the shot. It is understood that this image capture could be replaced by capturing the sound, with the analysis of the captured image being replaced by sound recognition. It is also understood that the image may be captured from a piece of printed or non-printed content, particularly a video stream.

The expression “environment of the terminal” particularly refers to the physical elements in the vicinity of the terminal, whose image may be captured by the terminal, such as buildings, billboards, posters, or bus shelters.

The term “object” advantageously refers to a bar code or other one-dimensional code delivering a piece of information, a tag (QR (quick response) code, datamatrix, microsofttag) and other two-dimensional codes, an image such as an outdoor advertisement, an advertisement printed in magazines, or an advertisement displayed on a screen.

Here, place associated with the object” particularly refers to a point of interest (POI), for example a point of presentation or sale of a company's products or services, the object containing an encoding of the company or a trademark. For example, the object is a tag encoding a trademark of franchised restaurants, and the place associated with the object is the closest restaurant to the location of the mobile terminal.

The location of the mobile terminal is advantageously taken into account to display the place associated with the object and the information associated with the object.

Here, “information associated with the object” particularly refers to a promotional offer (such as coupons, discount vouchers, loyalty points, and hybrid cards that can be used as credit cards or bank cards).

As will become more fully apparent in the remainder of the description, although the invention may be applied to mobile geomarketing, non-commercial applications are just as feasible.

Thus, for example, the object may be a tag placed on an industrial machine part, with the information associated with the object being a technical overview of the properties of the machine part, for the geolocated machine.

In certain implementations, the information associated with the object is independent of the location of the object and the terminal. For example, the object is a copy of an artwork, the place displayed on the mobile terminal is the location of the museum where the original artwork is currently found, and the information associated with the object is a short description of the artist. According to another example, the object is a logo, the place displayed on the mobile terminal is the location of a shopping center where products bearing that logo can be seen, and the information associated with the object is a short description of those products.

In certain implementations, the information associated with the object is dependent on the location of the object and/or the terminal. For example, the information is related to a place near the location of the object and/or terminal. For a given object, e.g. a brand logo or a tag, the information associated with the object, for example a promotional offer or an advertisement, will be different depending on the location of the object and/or the terminal. For example, the object is a branded sign, the place displayed on the terminal is the location of a chain store, and the information associated with the object is a description of that store in French, when the terminal is located in France.

In various embodiments, the identified object is chosen from the group comprising bar codes, tags, outdoor advertisements, advertisements printed in magazines, or advertisements displayed on screens.

The location of the terminal may particularly be obtained by GPS. In one embodiment, the object placed in the environment of the mobile terminal, such as a tag, encodes a piece of information of the object's location.

The term “advertising” should not be understood to mean messages promoting commercial products and services; rather, as used here it also refers to the promotion and announcement of non-profit and non-commercial products and services. The term “advertising” as used here also refers to institutional, educational, cultural, or civic announcements.

Advantageously, the display on the terminal of at least one place associated with the object used augmented reality. Advantageously, augmented reality allows POIs (Points Of Interest) to be superimposed on a mobile terminal's video capture.

In one embodiment, the method comprises a step of activating a guidance procedure from said location to at least one place associated with said object. Advantageously, from among multiple places associated with the object, the selected place is the place closest to the location of the terminal.

According to a second aspect, the invention pertains to a communication system comprising:

a database containing a plurality of images, each of which is associated with a predetermined place;

an application server, connected to the database, and configured to perform an image analysis of a shot received from a mobile terminal in order to identify within said shot an object corresponding to an image saved in the database.

a location server connected to the application server, configured to activate a procedure of displaying on the terminal at least one place associated with the object.

The analysis of the shot to identify an object can be performed within a remote communication system, or within the mobile terminal using a local application from an application server.

In one implementation, the location server is configured to remotely activate, within the terminal, a navigation system of a satellite positioning system implemented within the terminal.

Advantageously, the system comprises small cells for locating mobile terminals, particularly within buildings, such as train stations, shopping centers, and airports. These small cells are, for example, of the applicant's lightRadio® femtocell type.

Other objects and advantages of the invention will become apparent upon examining the description below with reference to the attached drawing, which illustrates a communication system and communication method compliant with the invention.

In the following description, the shot analysis and the detection of the presence of an object in that shot are performed within a remote communication system.

However, it is understood that the shot analysis and the detection of the presence of an object in that shot may be performed, in other implementations, within the mobile terminal, using a local application.

It is also understood that the shot analysis and the detection of the presence of an object may be performed partly within the mobile terminal and partly within a remote communication system.

The drawing depicts a network architecture 1 comprising a mobile terminal 2 (mobile telephony, communicating PDA, digital tablet, smartphone, electronic terminal connected to a vehicle), wirelessly connected to a communication system 3 comprising a media server 4, which handles the establishment of media sessions with the terminal 2, a video application server 5, connected to the media server 4 and on which an augmented reality application is advantageously implemented, a database 6 connected to or integrated into the video application server 5 and in which is saved images of objects and geographic coordinates of places associated with those objects, as well as a location server 7 connected to the video application server 5 and programmed to locate the terminal 2.

The media server 4 and the mobile terminal 2 are configured to establish between themselves media sessions (for example, in accordance with the RTP or H324m protocol), particularly enabling the exchange of audio/video data.

The mobile terminal 2 is equipped with a camera that makes it possible to take shots (photos, video) of the environment of the terminal 2.

The mobile terminal 2 is also equipped with a screen 8 allowing the display of images and video, as well as a (satellite, for example) positioning system comprising a navigation assistance application, whereby a two-dimensional or three-dimensional map 9 is advantageously displayed on the screen of the terminal 2, with the position of the terminal on the map, potentially associated with a programmed route.

The system 3 is configured to enable, based on a shot containing an object identifiable by the system 3, the guidance of the terminal 2 to a place associated with that object. This guidance procedure may comprise the display of the place's coordinates on the terminal, or guidance to the place from the location server 7.

Here, “guidance” refers to information on the existence of a place associated with said object, that information appearing in various forms: overlaying the object on a map in the location of said place, displaying the address of said place, displaying one or more routes and travel times between the terminal's location and said place.

A media session is first established (101), according an advantageously “real-time” protocol (such as RTP or H324m), between the terminal 2 and the communication system 3, and more specifically between the terminal 2 (at its own initiative) and the media server 4.

During the media server established between the terminal 2 and the media server4, a shot (video, photograph) is taken from the terminal 2, said shot including an object that can be identified by the system 3.

The shot is transmitted (102), in real time, by the terminal 2 to the media server 4.

Once it is received, the media server 4 isolates the shot and, potentially after decompression, transmits it (103) to the video application server 5 for analysis.

Using its augmented reality feature, the video application server 5 then performs an analysis (104), in “real time”, of the shot in order to detect therein the presence of an object whose image would be available in the database 6.

The video application server 6 is also operative to perform recognition of 3D objects from a plurality of shots (particularly taken from different viewpoints) to detect therein at least one 3D object.

Whenever such an object has been identified by its image, the video application server 5 extracts from the database 6 the geographic coordinates of the place (or places) associated with that object, and transmits them (105) to the location server 7. The location server 7 takes into account (e.g. after having determined it) the location of the terminal 2 and selects the place based on that location. When multiple places correspond to the same object in the database 6, selection may consist of choosing the place closest to the location of the terminal 2.

The location server 7 then transmits (106) the coordinates of the selected place to the terminal 2, or directly initializes the guidance procedure based on the location of the terminal 2.

According to a first, semi-automatic embodiment, the coordinates of the selected place are transmitted and then simply displayed on the terminal 2, and the opportunity to activate the guidance procedure on that terminal is left to the initiative of the user.

According to a second, automatic embodiment, at the same time that the coordinates of the selected place are transmitted, the location server 7 remotely activates on the terminal 2 the navigation application of the positioning system to allow guidance to the place.

According to a third, also automatic embodiment, the coordinates of the selected place are not transmitted to the terminal 2, the communication system 3 managing the application of the remote positioning system based on the location of the terminal 2.

To that end, the navigation application takes into account the current position of the terminal 2, and produces a route connecting that position and the selected place.

The route created this way may be simply displayed on the map 9 on the screen 8 of the terminal 2. In one variant, the navigation application directly triggers a procedure guiding the terminal 2 to the selected place, along the route created this way.

The terminal's location is obtained, in various embodiments, by a geolocation technique based on:
parameters taken separately or in combination from the propagation channel;
and/or the spatial signature of the terminal's environment.

In some embodiments, in a first step, an estimate is made of one or more parameters, at different reception points, those parameters being for example the received power, the arrival time (or difference between arrival times), the arrival direction(s), or departure direction(s) of at least one signal emitted by the mobile terminal. In a second step, a geometric reconstruction of the transmission point (i.e. the mobile terminal) is performed based on an intersection of (departure and/or arrival) directions and/or circle(s) (at a constant received power, at a constant arrival time, for example).

In other embodiments, in a first step, learning is performed by theoretical modeling and/or by experimental measurements of at least one signature (power, arrival time, delay spread, polarization, number of signals, departure and/or arrival directions, for example) of the signal on a grid of the location's environment. In a second step, a comparison is performed, such as by correlation, between the signature and preestablished signatures.

In one embodiment, the location of the terminal, particularly inside a building, is provided using small cells such as, for example, the applicant's lightRadio™ femtocells.

The object captured by the terminal's camera is advantageously chosen from the group comprising bar codes or other one-dimensional codes delivering a piece of information, tags (QR (quick response) code, datamatrix, microsofttag) and other two-dimensional codes, images such as an outdoor advertisement, advertisements printed in magazines, advertisements displayed on a screen, and sounds.

The capture (shot) may be taken by photography.

Advantageously, it is not necessary to take a photograph, and it is sufficient to point the camera towards the image that interests the user, such as the logo of a company or institution.

The method and system just described may be used for mobile geolocation communication purposes, in particular for mobile geomarketing.

In the following description of a mobile geomarketing application:
the term “brand” refers to a name or symbol whereby a company, association, or any other group communicates, for products or services. For example, the brand is a trademarked logo;
the phrase “point of sale” refers to a physical location where the brand's products and services are presented;
the phrase “offer” refers to a piece of information linked to a point of sale. For example, the offer is commercial (promotion, gift card, coupons, loyalty card, credit).

The characteristics of the points of sale, in particular their geographic locations, are imported into a database, as points of interest (POI).

The offers are imported into a database, such as in the form of a standard template, into which the images and text of the offers are placed.

In one implementation, when the marketing campaign is launched, a notification is sent to mobile terminals. This notification is, for example, a notification pushed to a smartphone, an SMS, an MMS, or an email.

Advantageously, this notification is sent to terminals in a way that takes into account the profile of the mobile terminal's user.

In one implementation, this notification is sent to mobile terminals found within a determined geographic area, by geofencing.

Advantageously, this notification asks the mobile terminal's user to access the dedicated application, allowing him or her to learn about current offers and store them in a dedicated list.

When the user takes a shot in the mobile terminal's environment, an analysis of the shot is performed, in order to detect therein the presence of an object such as a tag or bar code. When an object such as a tag or bar code has been identified by its image, the application identifies at least one point of sale associated with said tag.

Advantageously, the mobile terminal's location is then taken into account, and the offer displayed on the mobile terminal will be different based on the mobile terminal's location.

Advantageously, a point of sale and a piece of information, such as promotional information or community content, appear on the terminal's display.

Advantageously, the address of the point of sale, superimposed on a map and/or a route, appears on the terminal's display.

Advantageously, a back-end of the application manages the points of interest. An update to the POIs may thereby be performed for the brand. This update may consist of:
adding or removing a POI
adding, removing, or editing an offer linked to one or more POIs
editing information linked to the POIs, for example opening hours, telephone number, or email address.

With the help of this back-end, the notifications sent to the mobile terminals can be easily updated.

The method and device have applications in mobile geomarketing in shopping centers, train stations, and airports, with tags that help locate the mobile terminals indoors.

Advantageously, when the user approaches the POI, information appears on the screen of the mobile terminal, using augmented reality. This information is, for example, promotional offers (coupons).

The method and system just described exhibit many advantages.

They make it possible to add an informative, social dimension to the environment. Advantageously, the information is provided to the terminal using augmented reality, the POIs being the locations associated with the terminal's location, for the visual or audio object captured by the terminal's camera or microphone.

The inventive method and system make it possible to send promotional offers (such as coupons, discount vouchers, loyalty points, and hybrid cards that can be used as either credit cards or bank cards) corresponding to the user's profile, with the user him/herself indicating a center of interest.

In one variant, when the object is, for example, a tag scanned by the terminal, the terminal can be used to pay for an item associated with the tag.

In one variant, when the object is scanned by the terminal, the user can vote online, book online, buy online, or visit a polling station, which is the place associated with the scanned object.

The inventive method and system also make it possible to send information assumed to be relevant and interesting to the user, in the form of advice, suggestions, or information about a product, service, person, company, or site.

The inventive method and system also make it possible for the user to learn of products, services, and sites that have features in common with whatever attracted his/her attention. A tourism site may thereby be discovered in a way more suited to the user's tastes.

When the object is contained in a piece of media content, e.g. on the Internet or in a television program, the inventive method and system allow for game-like applications. In addition to a place associated with the scanned object (that object being, for example, a tag), the user will be offered media content that includes an event-related quiz or game.

For example, a user can photograph or film a logo designating a company or trademark and send it to the system 3, which extracts from the database 6 the address of the company or distributor of the brand closest to the location of the terminal 2. When the shot is a video, it is broken down frame by frame, then each frame is compared with the images in the database 6, using an image recognition technique.

1. A communication method comprising the following operations:
taking a shot, by a mobile terminal, in the environment of the terminal;
analyzing the shot to detect the presence therein of an object;
when an object has been identified by its image, identifying at least one place associated with said object;
taking into account the location of the terminal;
selecting from among a plurality of places associated with the object, a place associated with the object based on said location, the selected place being the place closest to the terminal's location;
displaying on the terminal at least one place and piece of information associated with the object.

2. A method according to claim 1, wherein the identified object is chosen from the group comprising bar codes, tags, outdoor advertisements, advertisements printed in magazines, or advertisements displayed on screens.

3. A method according to claim 1, wherein the display on the terminal of at least one place associated with the object is performed using augmented reality.

4. A method according to claim 1, wherein it comprises a step of activating a guidance procedure from said location to at least one place associated with said object.

5. A communication method according to claim 1, further comprising the following operations:
establishment of a media session between the mobile terminal and a remote communication system;
transmission of the shot by the mobile terminal to the communication system during the media session;
analysis of the shot, within the communication system, to detect therein the presence of said object.

6. A communication system comprising:
a database containing a plurality of images, each of which is associated with a predetermined place;
an application server, connected to the database, and configured to perform an image analysis of a shot received from a mobile terminal in order to identify within said shot an object corresponding to an image saved in the database.
a location server connected to the application server, configured to take into account the location of the mobile terminal, to select from among several places corresponding to said object in the database the place closest to said location, and to activate a procedure for displaying at least one place associated with the object on the terminal.

7. A communication system according to claim 6, wherein the location server is configured to remotely activate, within the terminal, a navigation system of a satellite positioning system implemented within the terminal.

8. A communication system according to claim 6, wherein it comprises a network of small cells for locating mobile terminals, particularly indoors.
